(19) United States
(12) Patent Application Publication
(10) Pub. No.: US 2024/0124654 A1
(43) Pub. Date: Apr. 18, 2024

(54) ANIONIC POLYMERIZATION OF SILOXANES

(71) Applicant: RUDOLF GMBH, Geretsried (DE)

(72) Inventors: Andreas WENNG, Haar (DE); Alexander HOFER, Benediktbeuern (DE); Gunther DUSCHEK, Benediktbeuern (DE); Dirk SIELEMANN, Wolfratshausen (DE)

(73) Assignee: RUDOLF GMBH, Geretsried (DE)

(21) Appl. No.: 18/370,654

(22) Filed: Sep. 20, 2023

(30) Foreign Application Priority Data
Sep. 29, 2022 (EP) 22198742.3

(51) Int. Cl. C08G 77/08; B01J 23/04; B01J 35/02; B01J 35/10; B01J 37/08; C08G 77/10

(52) U.S. Cl. CPC C08G 77/08; B01J 23/04; B01J 35/026; B01J 35/1019; B01J 35/1038; B01J 35/1066; B01J 37/08; C08G 77/10

(57) ABSTRACT

The invention relates to a catalyst pellet for anionic polymerization of organosiloxanes and/or for equilibration of organopolysiloxanes, comprising at least one (earth) alkali metal oxide, its preparation, as well as a method for polymerization of organosiloxanes and/or for equilibration of organopolysiloxanes by means of the catalyst pellet.

This application claims priority under 35 U.S.C. § 119(a) to Europe Application No. EP 22198742.3 filed Sep. 29, 2022, the disclosure of which is expressly incorporated by reference herein in its entirety.

The invention relates to a catalyst pellet for the anionic polymerization of organosiloxanes and/or for the equilibration of organopolysiloxanes, comprising at least one (earth) alkali metal oxide, its preparation, and a method for the polymerization of organosiloxanes and/or for the equilibration of organopolysiloxanes by means of the catalyst pellet.

EP 3 599 256 B1 discloses the polymerization of siloxanes with the aid of a basic initiator, preferably selected from the group of nitrogen bases, and a hydroxy-functionalized compound such as water, from the group of the linear or branched alcohols or silanols from the group of triorganosilanols in the presence of a polar aprotic solvent. The organopolysiloxanes prepared in this way are immiscible with the solvent at room temperature. Separation of the solvent and, if necessary, purification of the prepared polymer are required.

WO 2006/122704 discloses the polymerization of hexaorganocyclotrisiloxanes (D₃) with sil(ox)anols in the presence of a supported catalyst selected from the group of (earth) alkali metal carbonates and/or (earth) alkali metal oxides in the solvent. The method is carried out in batch operation. Diorganopolysiloxanes are generated which have a terminal hydroxyl group. The reaction mixture must be filtered and distilled in order to obtain the silicone oil. Discontinuation of the reaction at incomplete conversion can be accomplished by cooling to room temperature, filtration of the solid catalyst used from the viscous final product, or by addition of an acid. When acid is added, salt precipitates form, requiring further filtration steps.

EP 1 988 115 A1 discloses a method for the preparation of organopolysiloxanes having aminoalkyl groups by converting linear, cyclic or branched organopolysiloxanes with aminoalkylsilanes in the presence of a basic catalyst selected from the group of alkali metal hydroxides, alkali metal alcoholates and alkali metal siloxanolates. The method is carried out in a continuous process. The basic catalysts used must be deactivated following the conversion, for example by adding neutralizing agents or inhibitors. Solids formed are usually removed by continuous filtration or continuous extraction methods.

The prior art methods have the disadvantage that downstream deactivation steps and/or complex filtration steps have to be carried out.

It is therefore the object of the present invention to provide an improved catalyst for the anionic polymerization of organosiloxanes and to utilize said catalyst in an improved method.

Surprisingly, it was found that hydroxy-functional organopolysiloxanes can be provided in high yields using catalysts according to the present invention. It is further observed that the organopolysiloxane obtained essentially does not condense to higher molecular weight organopolysiloxanes.

In one aspect, therefore, the present invention relates to a catalyst pellet for anionic polymerization of organosiloxanes and/or for equilibration of organopolysiloxanes comprising.
(i) at least one (earth) alkali metal oxide, and
(ii) optionally at least one binding agent or at least one carrier material, characterized in that the CO₂ desorption enthalpy of the catalyst pellet is 25-350 kJ/mol, preferably 50-300 kJ/mol, and more preferably 50-200 kJ/mol, as measured by temperature programmed desorption of CO₂.

Component (i) comprises at least one (earth) alkali metal oxide. Preferably, the (earth) alkali metal oxide is selected from sodium oxide, potassium oxide, rubidium oxide, cesium oxide, beryllium oxide, magnesium oxide, calcium oxide, strontium oxide or barium oxide, in particular calcium oxide or magnesium oxide, more preferably magnesium oxide.

The (earth) alkali metal oxide, independently of each another, preferably has a mean pore radius of 2-130 nm, preferably 2-65 nm, more preferably 2-35 nm. The pore radius is determined according to DIN 66134 on the basis of the pure (earth) alkali metal oxide.

Without being bound by any theory, it is believed that a critical mean pore radius of at least 2 nm is essential for the diffusion of monomer (organosiloxane) and polymer, in particular linear organopolysiloxane, into and out of the pore.

The (earth) alkali metal oxide of component (i) independently has independently of each other a specific pore volume of 0.2-1.2 ml/g, more preferably of 0.2-0.6 ml/g, even more preferably of 0.2-0.45 ml/g, measured according to DIN 66134 on the basis of the pure (earth) alkali metal oxide.

The (earth) alkali metal oxide of component (i) has, independently of each another, preferably a mass-specific surface area of 35-400 m²/g, more preferably 75-375 m²/g, still more preferably 125-350 m²/g, measured according to DIN ISO 9277 on the basis of the pure (earth) alkali metal oxide.

In a preferred embodiment, the catalyst pellet consists of component (i).

In another embodiment, the proportion by weight of component (i) relative to the total weight of the catalyst pellet preferably constitutes 0.1-100 wt %, more preferably from 1-100 wt %, more preferably 10-100 wt %, even more preferably 20-99.9 wt %, and most preferably 50-99.9 wt %.

In a preferred embodiment, the X-ray diffraction pattern of magnesium oxide as the (earth) alkali metal oxide of component (i) in the X-ray diffraction pattern (copper Kα: 0.154056 nm) exhibits the five strongest signals at 2θ=37°, 43°, 62°, 75° and 78°.

In a preferred embodiment, the X-ray diffraction pattern of calcium oxide as (earth) alkali metal oxide of component (i) in the X-ray diffraction pattern (copper Kα: 0.154056 nm) exhibits the six strongest signals at 2θ=32°, 37°, 53°, 64°, 67° and 79°. The X-ray diffraction pattern is measured by methods known to the skilled person, for example according to DIN EN 13925-1.

The (earth) alkali metal oxide of component (i) is preferably obtained by calcining the respective (earth) alkali hydroxide, (earth) alkali carbonate, (earth) alkali nitrate, (earth) alkali sulfate, (earth) alkali acetate, (earth) alkali oxalate, (earth) alkali phosphate, more preferably the respective (earth) alkali hydroxide.

“Calcination” or “calcining” shall be understood to mean the controlled heating of substances, whereby by-products, in particular H₂O and/or C₂, in the case of earth alkali hydroxide in particular H₂O, are cleaved off. For this purpose, the respective (earth) alkali starting material (hydroxide, carbonate, nitrate, sulfate, acetate, oxalate, phosphate) is heated at 300-900° C., more preferably at 350-650° C., even more preferably at 375-550° C. For this purpose, the calcination reaction may be carried out in provided vessels, optionally with stirring. The duration of the calcination method can be carried out in the range of 10-240 minutes, more preferably in the range of 60-210 minutes, even more preferably in the range of 90-150 minutes. The by-products produced by the calcination can be removed from the reactor either continuously or in batches. At the end of calcination, the material is cooled at standard ambient conditions, e.g., 1000 hPa, 20° C. The calcination and/or cooling phase is preferably carried out under air, oxygen or inert gas atmosphere, more preferably under inert gas atmosphere, such as nitrogen, helium and/or argon.

For calcination, the (earth) alkali hydroxides, (earth) alkali carbonates, (earth) alkali nitrates, (earth) alkali sulfates, (earth) alkali acetates, (earth) alkali oxalates, (earth) alkali phosphates, more preferably (earth) alkali hydroxides, are used in the form of powder particles, agglomerates or pellet precursors, preferably pellet precursors. In particular, the powder particles or agglomerates have an mean particle size of about 0.5-450 μm, preferably 1 μm-300 μm, measured according to DIN 66165.

In one embodiment, the catalyst pellet may comprise at least one binding agent or at least one carrier material, preferably at least one binding agent.

Preferably, the binding agent is selected from organic or inorganic binding agents. Organic binding agents are preferably phenolic resins, polyisocyanates, polyurethanes, polymeric alcohols, urea-aldehyde condensates, furfuryl alcohol, acrylic acid and acrylate dispersions, peroxides, sugar alcohols, proteins, epoxy resins, furan resins, carbohydrates, sugars, carboxymethyl cellulose, xanthan gum, gelatin, polyethylene glycols, polyvinyl alcohols, polyvinyl pyrrolidones or mixtures thereof. Inorganic binding agents are preferably phyllosilicates, in particular bentonite, sodium silicate, sodium aluminate, aluminosilicates, silicic acid and esters thereof, brines or colloidal solutions of silicon dioxide. Binding agents can form covalent or electrostatic networks with the (earth) alkali metal oxide or with themselves.

Preferably, the carrier material of component (ii) is selected from aluminum oxide, zirconium oxide, silicon dioxide, titanium oxide, titanium dioxide, metal phosphate such as hydroxyapatite, cerium oxide and carbon, as well as mixed oxides such as SiO₂—Al₂O₃, SiO₂—TiO₂, ZrO₂—SiO₂, ZrO₂—Al₂O₃ or mixtures of two or more of these materials. Carrier materials are preferably inert and do not react with the catalyst or with themselves.

In a preferred embodiment, the carrier material is different from the binding agent.

In a preferred embodiment, the binding agent as well as the carrier material are catalytically inert.

In one embodiment, the catalyst pellet is free of binding agent or carrier material. In another embodiment, the binding agent of component (ii) is present in an amount of 0-40 wt %, more preferably 0-20 wt %, even more preferably 0.1-15 wt %, and most preferably 2-10 wt % based on the total weight of the catalyst pellet.

The carrier material of component (ii) preferably constitutes 0-99.9 wt %, more preferably 0-80 wt % and even more preferably 0-50 wt % based on the total weight of the catalyst pellet.

Preferably, the catalyst pellet may further comprise
(iii) at least one oxide of an element of the 3^{rd} to 12^{th} main groups or of the lanthanides. Cerium oxide, lanthanum oxide, molybdenum oxide, zirconium oxide, manganese oxide, titanium oxide, iron oxide, cobalt oxide, nickel oxide, copper oxide and zinc oxide have proven to be particularly advantageous, more preferably lanthanum oxide, cerium oxide and copper oxide. The additional component (iii) leads to an increase in yield. Component (iii) is preferably present in a proportion by weight of 1-50 wt %, even more preferably 5-30 wt %, most preferably 5-25 wt %, based on the total weight of component (i).

The above-mentioned oxides are obtained analogously to component (i), preferably by calcination of the hydroxides, carbonates, nitrates, acetates, oxalates, phosphates or sulfates of the 3rd to 12th main groups or of the lanthanides.

In a preferred embodiment, the catalyst pellet has a water content of 0.01-0.5 wt %, more preferably 0.01-0.3 wt %, based on the total weight of the catalyst pellet.

The catalyst pellet has a CO₂₋ desorption enthalpy of 25-350 kJ/mol, preferably of 50-350 kJ/mol, and further preferably of 50-200 kJ/mol, as measured via the temperature programmed desorption of CO₂ (CO₂-TPD). The CO₂-TPD is a measure of the base strength of the catalyst pellet, which is significant for the catalytic activity. The measurement is carried out according to the method described by Leon et al. (M Leon, E. Diaz, A. Vega, S. Ordonez, A kinetic study of CO₂ desorption from basic material: Correlation with adsorption properties, Chemical Engineering Journal, 2011, 157, 341-348). The contents of the reference regarding measurement methods and underlying theory are hereby incorporated.

The catalyst pellet according to the present invention preferably has a cylindrical or spherical form.

The catalyst pellet is preferably a separate unit and preferably has a weight of 0.01-200 g.

Preferably, the internal porosity of the catalyst pellet is in a range of 5-99.9%, preferably between 15-90% and more preferably between 20-80%, based on the total geometric volume of the catalyst pellet.

The internal porosity describes the ratio of the internal void volume (V_{H}) to the total geometric volume (V_{P}) of a catalyst pellet. It is defined as:

ε=V/V_{HP}

Experimentally, the void volume is determined by mercury porosimetry (DIN 66133).

The catalyst pellet has a mass specific surface area of 0.25-1000 m²/g, preferably 0.5-800 m²/g, more preferably 1 m²/g to 600 m²/g measured according to DIN ISO 9277.

Preferably, the catalyst pellets are used as a bulk (particle collective) in the reactor.

The Sauter mean diameter is defined as the ratio of 6 times the total volume of the particle collective V_{P,total} to the total surface area of the particle collective S_{P,total}:

d₃₂=6* V_{P,total}/S_{P,total}

In order to determine the total surface area and the total volume of the particle collective, it is fictitiously assumed that the internal free volume of the particles is filled with solid, so that it can also be referred to as the geometric surface area and volumes, respectively.

For particles that have large, internal volumes, the resulting areas are considered as part of the geometric (external) surface. An example of this are hollow cylinders.

The Sauter mean diameter d₃₂ is related to the volume-to-surface area ratio of a particle collective and defines the fictitious particle diameter of the spheres having the same volume that in total have the same volume-to-surface area ratio as the particle collective.

In a preferred embodiment, the catalyst pellet has a Sauter mean diameter of 1-50 mm, more preferably 1.5-20 mm and more preferably 1.5-5 mm. The Sauter mean diameter is determined according to DIN ISO 9276-2.

Another aspect of the present invention relates to a method for preparing the catalyst pellet described above comprising the steps of.
a) providing an (earth) alkali hydroxide, an (earth) alkali carbonate, an (earth) alkali nitrate, an (earth) alkali sulfate, an (earth) alkali acetate, an (earth) alkali oxalate, an (earth) alkali phosphate or a mixture thereof and optionally at least one hydroxide, carbonate, nitrate, acetate, oxalate, phosphate or sulfate of an element of the 3^{rd} to 12^{th} main groups or of the lanthanides as starting material,
b)
   b1) optionally applying the starting material to a carrier material, or
   b2) optionally mixing the starting material with at least one binding agent,
c) providing the starting material or the mixture obtained after step b1) or b2) as a pellet precursor,
d) optionally drying of the pellet precursor obtained after step c) and
e) calcining the dried pellet precursor obtained after step c) or d) to produce the catalyst pellet.

In a preferred embodiment, the pellet precursor comprises.
1-100 wt % starting material,
0-20 wt % binding agent or
0-99 wt % carrier material,
based on the total weight of the pellet precursor.

In one embodiment, the starting material after step a) is optionally mixed with at least one solvent and formed into a pellet precursor. The solvent may be organic polar or non-polar solvents. Examples include water, methanol, ethanol, isopropanol, butanol, acetone, methyl ethyl ketone, methyl propyl ketone, xylene, toluene, cyclohexane, heptane, octane and nonane, with water, methyl ethyl ketone, isopropanol and ethanol and in particular water being/is preferred.

The pellet precursor is provided by conventional shaping of the starting material, optionally mixed with a solvent. Preferred methods are granulation, pressing, extrusion, 3D printing, tabletting and spray drying.

In another embodiment, the starting material is applied to a carrier material. The carrier material is preferably as described above. The starting material is applied to the carrier material by methods known to the person skilled in the art. Preferably, the starting material is mixed, e.g. dispersed or dissolved, in at least one solvent, and applied in this form to the carrier material. Preferred solvents have already been described above.

In one embodiment, the carrier material may already represent the form of the pellet precursor. Providing the pellet precursor in step c) may optionally comprise the drying of the mixture obtained after step b1).

In another embodiment, the mixture obtained after step b1) may be formed to a pellet precursor. Suitable forming methods are granulation, pressing, extrusion, 3D printing, tabletting and spray drying.

In a further embodiment, the starting material, the binding agent and optionally at least one solvent are mixed in step b2). Preferred solvents are described above. The mixing can be carried out in conventional mixers, tumblers and masticators. The amount of solvent in step b2) is preferably 0-99 wt %, more preferably 5-95 wt %, most preferably 10-90 wt % based on the total weight of the mixture.

The mixture obtained after step b2) can be formed into pellet precursors in step c) by conventional methods known to the skilled person. Preferred methods are granulation, pressing, extrusion, 3D printing, tabletting and spray drying.

The pellet precursor preferably has a shape corresponding to the catalyst pellet.

The amount of solvent after step b) is preferably 0-99 wt %, more preferably 5-95 wt %, most preferably 10-90 wt % based on the total weight of the mixture.

If necessary, in step d), the pellet precursor obtained after step c) can be dried, e.g., at 80-120° C.

The solvent content after step c) or d) is preferably 0-10 wt %, more preferably 0-5 wt % based on the total weight of the pellet precursor.

According to step e), the pellet precursor obtained after step c) or d) is calcined as described above. The pellet precursor is preferably calcined at 300-900° C., more preferably at 350-650° C., even more preferably at 375-550° C. The calcination reaction may be carried out in vessels provided for this purpose, optionally with stirring. The duration of the calcination method can be carried out for a period in the range of 10-240 minutes, more preferably in the range of 60-210 minutes, even more preferably in the range of 90-150 minutes. At the end of the calcination, the material is cooled at standard ambient conditions, e.g., 1000 hPa, 20° C. The calcination and/or cooling phase is preferably carried out under air, oxygen or inert gas atmosphere, more preferably under inert gas atmosphere, such as nitrogen, helium and/or argon.

The present invention further relates to a catalyst pellet that is obtained by the method described above.

Another aspect of the present invention relates to the use of the catalyst pellet described above for anionic polymerization and/or equilibration, in particular for the polymerization of cyclic and linear organosiloxanes and/or the equilibration of organopolysiloxanes.

“Equilibration” means the rearrangement of siloxane bonds in an equilibrium reaction without the cleavage of water or alcohol.

In contrast, a condensation reaction means the reaction of two bonded hydroxy groups, in particular Si-bonded hydroxy groups, under cleavage of water or the reaction of a bonded hydroxy group, in particular a bonded Si hydroxy group, with a bonded alkoxy group, in particular a Si-bonded alkoxy group, under cleavage of alcohol.

Surprisingly, it was found that functional organopolysiloxanes having at least one hydroxy group can be prepared by using the specific catalysts without substantially condensation to organopolysiloxanes having higher molecular weight taking place. Preferably, less than 5%, more preferably 0.01-1% condensation reactions occur based on the total polymerization reactions that take place. The water in the product resulting from the condensation reactions was measured by Karl Fischer titration according to ISO 760 and is a measure of the occurrence of condensation reactions.

It has further been surprisingly found that the catalyst pellets of the present invention are particularly suitable for converting the organosiloxane monomers to the desired organopolysiloxanes in high yield. It has further been shown that the catalyst pellets can be processed, for example by calcination, and can be reused for the above reactions.

Another object of the present invention is a method for polymerizing organosiloxanes and/or equilibrating organopolysiloxanes by reacting
(A) organocyclosiloxanes of general formula (I)

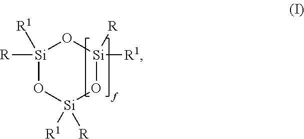

and/or linear block organopolysiloxanes of general formula (II)

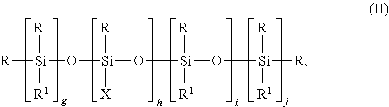

and linear, random or alternating organopolysiloxanes having the molecular formula of general formula (II),
   and optionally a compound of general formula (III)

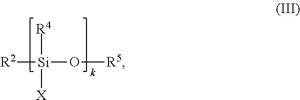

with
(B) an initiator of the general formula (IV)

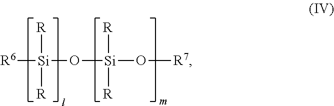

where
   R independently of each other is a monovalent, optionally substituted C₁-C₃₀ hydrocarbon residue,
   R¹ is independently of each other a monovalent, optionally substituted C₁-C₃₀ hydrocarbon residue or a polyether residue,
   f is an integer from 1 to 10, preferably an integer from 1 to 4, in particular 2,
   g is 0 or 1,
   h is 0 or an integer from 1 to 1000, preferably 5-800,
   i is 0 or an integer from 1 to 1000, preferably 5-800,
   j is 0 or 1,
   with the proviso that at least one of g, h, i, or j≠0,
   R² is a hydroxy group or —OR³,
   R³ is a monovalent C₁-C₃₀ hydrocarbon residue,
   R⁴ for k=1 is a monovalent C₁-C₃₀ hydrocarbon residue or R¹ and
      for k≠1 is independently of each other a monovalent C₁-C₃₀ hydrocarbon residue,
   R⁵ is a hydrogen or a monovalent C₁-C₃₀ hydrocarbon residue,
   X is independently of each other a monovalent C₁-C₃₀ hydrocarbon residue or a functionalized residue,
   k is an integer from 1 to 500, preferably 1 to 400, more preferably 1 to 300
   R⁶ is R or hydrogen,
   R⁷ is R or hydrogen,
   l is 0 or 1,
      with the proviso that when l=0, R⁶ and/or R⁷ must be a hydrogen and when l≠0, R⁷ must be a hydrogen and R⁶ must be R, and
   m is 0 or an integer from 1 to 100, preferably 5-80,
(C) in the presence of at least one catalyst pellet as defined above,
(D) optionally in the presence of a solvent, and
(E) optionally in the presence of a phase transfer catalyst.

The residue R is independently of each other a monovalent, optionally substituted C₁-C₃₀ hydrocarbon residue. A C₁-C₃₀ hydrocarbon residue in the sense of the present invention has a molecular formula with 1-30 C atoms. Examples of C₁-C₃₀ hydrocarbon residues are alkyl residues, such as methyl, ethyl, n-propyl, iso-propyl, n-butyl, iso-butyl, tert.-butyl, n-pentyl, iso-pentyl, neo-pentyl, tert.-pentyl, hexyl, such as n-hexyl, heptyl, such as n-heptyl, octyl, such as n-octyl and iso-octyl, such as 2,2,4-trimethylpentyl, nonyl, such as n-nonyl, decyl, such as n-decyl, dodecyl, such as n-dodecyl residues, alkenyl residues, such as vinyl, allyl, 5-hexenyl and 10-undecenyl residues, cycloalkyl residues, such as cyclopentyl, cyclohexyl, cycloheptyl and methylcyclohexyl residues, aryl residues, such as phenyl and naphthyl residues; alkaryl residues, such as o-, m-, p-tolyl residues, xylyl and ethylphenyl residues, aralkyl residues, such as benzyl, α- and β-phenylethyl residues, in particular methyl, ethyl, iso-propyl or allyl residues.

In one embodiment, the hydrocarbon residue R is unsubstituted. In another embodiment, the hydrocarbon residue is substituted. Suitable substituents include halogen, such as fluorine, chlorine, bromine, iodine, acyloxy, (meth)acryloxy, silylalkyl, vinyloxy, thiol, cyano, carbonyl, and amino. Preferred substituted hydrocarbon residues R are 3-chloropropyl, 3,3,3-trifluoro-n-propyl, 2,2,2,2′,2′,2′-hexafluoroisopropyl, heptafluoroisopropyl, haloaryl, in particular o-, m-, p-chlorophenyl, acetoxyethyl, (meth)acryloxypropyl, 2-acryloxyethyl, 2-(2-acryloxyetoxy)-ethyl, trimethylsilylmethyl, 4-vinyloxy-1-butyl, 4-(vinyloxymethyl)-cyclohexyl-1-methyl, 2-mercapto-1-ethyl, 1-mercaptopropyl, 2-cyano-1-ethyl, 2-oxo-1-propyl and 2-N,N-dimethylamino-2-propyl.

R¹ is independently of each other a monovalent, optionally substituted C₁-C₃₀ hydrocarbon residue as defined above or a polyether residue. The polyether residue is preferably selected from a block, random or alternating polyether of the general molecular formula (V):

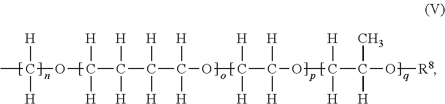

wherein
R⁸ is a monovalent, optionally substituted C₁-C₃₀ hydrocarbon residue as defined above,
n is 0 or an integer from 2-30,
o is 0 or an integer between 1-50,
p is 0 or an integer from 1-50, and
q is 0 or an integer from 1-50,

Preferred organocyclosiloxanes of general formula (I) are cyclotrisiloxanes, cyclotetrasiloxanes, cyclopentasiloxanes, cyclohexasiloxanes or mixtures thereof. In particular, hexamethylcyclotrisiloxane, hexaethylcyclotrisiloxane, 1,3,5-trimethyl-1,3,5-triethylcyclo-2,4,6-trisiloxane, 1,3,5-trimethyl-1,3,5-triphenylcyclo-2,4,6-trisiloxane and 1,3,5-trimethyl-1,3,5-tris(3,3,3-trifluoropropyl)cyclo-2,4,6-trisiloxane, octamethylcyclotetrasiloxane, 1,3,5,7-tetramethyl-1,3,5,7-tetravinylcyclotetrasiloxane, 1,3,5,7-tetrakis(3,3,3-trifluoropropyl)-1,3,5,7-tetramethylcyclotetrasiloxane, 2,4,6,8-tetramethyl-2,4,6,8-tetraphenylcyclotetrasiloxane, decamethylcyclopentasiloxane, 2,4,6,8,10-pentaethenyl-2,4,6,8,10-pentamethylcyclopentasiloxane and dodecamethylcyclohexasiloxane are preferred. Particularly preferred is the organocyclosiloxane of general formula (I) octamethylcyclotetrasiloxane.

The linear organopolysiloxanes of general formula (II) may be present as block, random or alternating polymers, and have the molecular formula

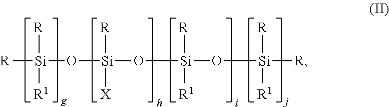

wherein
R, R¹ are as defined above,
g is 0 or 1,
h is 0 or an integer from 1 to 1000, preferably from 5-800,
i is 0 or an integer from 1 to 1000, preferably from 5-800,
j is 0 or 1,
   with the proviso that at least one of g, h, i, or j≠0,

The organopolysiloxanes of general formula (II) are preferably non-reactive polyalkylsiloxanes, such as polymethylsiloxanes, in particular hexamethyldisiloxane.

In the compound of general formula (III)

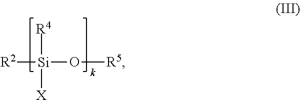

R² is a hydroxy group or —OR³, wherein R³ is preferably a monovalent C₁-C₃₀ hydrocarbon residue, as defined above.
R⁴ for k=1, is a monovalent C₁-C₃₀ hydrocarbon residue or R¹, as defined above, and
   for k≠1 is independently of each other a monovalent C₁-C₃₀-hydrocarbon residue as defined above,
k is an integer from 1 to 500, preferably from 1 to 400, more preferably from 1 to 300,
R⁵ is hydrogen or a monovalent C₁-C₃₀ hydrocarbon residue as defined above,
X is independently of each other a monovalent C₁-C₃₀ hydrocarbon residue as defined above or a functionalized residue, preferably selected from the general formula (VI)

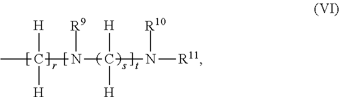

wherein
   R⁹ is R, a hydrogen or acyl residue, preferably a hydrogen,
   R¹⁰ is R or a hydrogen, preferably hydrogen,
   R¹¹ is R, a hydrogen or an acyl residue, preferably hydrogen,
   r is an integer from 2 to 3,
   s is an integer from 1 to 3, and
   t is 0 or an integer from 1 to 4, preferably 0 to 1.

According to the present invention, t are in particular amino units and s are in particular methylene units, which can be distributed arbitrarily in the functionalized residue.

Preferred compounds of general formula (III) are (3-aminopropyl)diethoxymethylsilane, (3-aminopropyl)dimethoxymethylsilane, (3-aminopropyl)trimethoxymethylsilane, (3-aminopropyl)triethoxymethylsilane, [N-(2-aminoethyl)-3-aminopropyl]dimethoxymethylsilane, [N-(2-aminoethyl)-3-aminopropyl]diethoxymethylsilane, [N-(2-aminoethyl)-3-aminopropyl]trimethoxysilane, [N-(2-aminoethyl)-3-aminopropyl]triethoxysilane, (aminoethyl)dimethoxymethylsilane, (aminoethyl)diethoxymethylsilane, (aminoethyl)trimethoxysilane, (aminoethyl)triethoxysilane, particularly preferred are (3-aminopropyl)dimethoxymethylsilane, (3-aminopropyl)trimethoxymethylsilane, [N-(2-aminoethyl)-3-aminopropyl)dimethoxymethylsilane, [N-(2-aminoethyl)-3-aminopropyl)trimethoxymethylsilane.

Compounds of general formula (IV) serve as initiators:

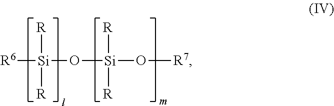

wherein
l is 0 or 1,
   with the proviso that when l=0, R⁶ and/or R⁷ must be a hydrogen and when l≠0, R⁷ must be hydrogen and R⁶ must be R,
m is 0 or an integer from 1 to 100, in particular 5-80,
R is as defined above,
R⁶ is R or hydrogen and
R⁷ is R or hydrogen.

Compounds of general formula (IV) serve as initiators and comprise compounds having at least one hydroxy group. This may be terminal and/or lateral. Compounds with a terminal hydroxy group are preferred. Particularly preferred are alkanols, sil(oxa)noles, hydroxyallyl acrylates, hydroxyallyl methacrylates, in particular methanol, ethanol, 1-propanol, isopropanol, 1-butanol, 2-butanol, tert-butanol, trimethylsilanol, α,ω-dihydroxypolydimethylsiloxane and hydroxyethyl methacrylate, more preferably butanol or trimethylsilanol.

The initiator of general formula (IV) is preferably used in amounts of 0.003-1 mol, preferably of 0.003-0.7 mol and particularly preferably of 0.003-0.65 mol based on 1 mol of the compound of formula (I) and/or (II). The amount of initiator used controls the mean chain length and, accordingly, the viscosity of the prepared organopolysiloxanes.

The initiators used may contain traces of water, which leads to undesired formation of dihydroxypolysiloxanes. Therefore, a water content of the initiator is less than 1 wt %, more preferably 0.0001-0.1 wt %. If necessary, the water present in the initiator must be separated by drying agents or by distillation before the reaction. Suitable drying agents are anhydrous sodium sulfate, anhydrous magnesium sulfate, anhydrous calcium sulfate, zeolites, layered silicates or silica gel. It may be advantageous to exclude traces of moisture in the starting compounds by incorporating the above-mentioned drying agents upstream of the catalyst in order to obtain a more uniform product quality.

The catalyst pellet is as described above. Suitable catalysts can be used individually or as a mixture of at least two catalysts described.

Furthermore, the method can take place in the presence of a solvent. Suitable solvents are non-polar organic solvents, in particular xylene, toluene, cyclohexane, heptane, octane, nonane or mixtures thereof. The solvent can be added as needed to improve homogenization of the reaction mixture.

In order to increase the reaction rate, aprotic, polar organic solvents may also be used, optionally as a mixture with a non-polar organic solvent as described above. Examples of aprotic polar organic solvents are dimethyl sulfoxide, acetonitrile, acetone, tetrahydrofuran, methyl ethyl ketone, methyl propyl ketone, dimethyl formamide or mixtures thereof.

In order to further increase the reaction rate as well as selectivity, phase transfer catalysts can be added to the reaction. Common phase transfer catalysts are known to the person skilled in the art. Benzyltriethylammonium chloride, crown ethers, such as 18-Crown-6 and 12-Crown-4, polyethylene glycol diethyl ether or tertiary amines, such as 4-dimethylaminopyridine or N,N-dimethylcyclohexylamine are preferred.

Preferably, catalyst (C) is in a different aggregate state than components (A), (B) and (D).

Preferably, the method according to the present invention is carried out in a continuous process. Reactors in which the catalyst pellet is immobilized are preferred. Particularly preferred reactors are therefore fixed bed reactors, tubular reactors and loop reactors. Particularly preferred loop reactors are described, for example, in EP 3 374 077, the contents of which are also the subject-matter of the present invention.

The method is preferably carried out in a temperature range of 60-200° C., more preferably 80-180° C., even more preferably 120-170° C. The reaction may take place under normal, elevated or reduced pressure. Preferably, the method takes place under normal conditions, in particular at 950-1100 hPa.

Preferably, the reaction is carried out with a weight hourly space velocity (WHSV) in the range of 1-30 h⁻¹, preferably 3-30 h⁻¹, even more preferably 3-24 h⁻¹, most preferably in a range of 3-15 h⁻¹.

Weight hourly space velocity means the weight of feed flowing per unit weight of catalyst per hour. Since the weight of the catalyst introduced into the reactor is preferably not changed and preferably always the same, any change in the fluid flow per hour changes the weight hourly space velocity.

The residence time in the reactor varies depending on the amount of catalyst used, the length of the fixed bed, the reaction temperature of the volume flow, and the type and amount of reactants used. It is preferably in the range of 5 minutes to 48 hours, more preferably between 5 minutes and 24 hours, further preferably between 5 minutes and 6 hours, and most preferably in a range between 5 minutes and 4 hours.

The reaction can be carried out until full conversion or until the equilibrium point is reached. At the equilibrium point, the maximum viscosity is reached and no further increase in viscosity can be observed. Alternatively, the conversion control can be determined by determining the dry residue, hereinafter referred to as dry substance, following DIN EN 12880. However, the reaction can also be stopped before full conversion or the equilibrium point is reached.

It has been found that the catalyst pellet according to the present invention is stable over the run time of the manufacturing method according to the present invention. “Stable” in the sense of the present application means that the catalyst exhibits a loss of activity of less than 10%, preferably less than 5%, after a run time of 200 hours.

Furthermore, the catalysts according to the present invention have been found to be storage stable. “Storage stable” in the sense of the present invention means that the activity of the catalyst immediately after calcination remains essentially unchanged from the activity of the catalyst 80 days after calcination (storage at room temperature in the absence of air).

Should the activity of the catalyst decrease after very long running times or very long storage time, it has surprisingly been shown that the activity of the catalyst can essentially be recovered by an additional calcination method. For this purpose, the spent catalyst - if necessary - is preferably first cleaned of organic residues by using solvents, for example isopropanol or acetone, and then heated at 300-500° C. for two to five hours. By this reactivation can restore an activity of 90-100% of the original activity.

It is believed that the re-calcination step can remove organopolysiloxane encrustations and any adsorbed water and carbon dioxide from the surface of the catalyst, thus restoring the original activity centers on the surface of the catalyst.

According to the method of the present invention, there is no need to stop the reaction or separate the product from catalyst. Furthermore, there is no need to deactivate the reaction mixture by acid.

In another aspect, the present invention relates to an organopolysiloxane which can be obtained by the method as described above.

Preferably, the organopolysiloxanes of the invention have a viscosity of 5-10⁴ mPas, more preferably of 5-5000 mPas, even more preferably of 5-2000 mPas, measured according to DIN 53019 at 20° C.

The present invention will be explained in more detail with reference to the following embodiments. However, the invention is not limited thereto.

### BRIEF DESCRIPTION OF DRAWINGS

FIG. 1 shows the effect of calcination on catalytic activity;

FIG. 2 shows pore size distribution as a function of calcination temperature;

FIG. 3 shows pore volume as a function of calcination temperature;

FIG. 4 shows mass specific surface as a function of calcination temperature;

FIG. 5 shows the effect of calcination duration on the conversion of Mg(OH)₂ at a temperature of 400° C.,

FIG. 6 shows conversion as a function of calcination temperature at 3 h;

FIG. 7 shows temperature programmed desorption of CO₂: base strength;

FIG. 8 shows ²⁹Si-NMR Spectrum; and

FIG. 9 show a ¹H-NMR Spectrum.

### EMBODIMENTS

### 1. Preparation of the Catalyst

### 1.1 Preparation of the Powdered Catalyst

10 g of powdered magnesium hydroxide was weighed into a crucible and dried at 80 and 120° C. for 1 hour each. The dried magnesium hydroxide was then calcined under static air at a temperature range of 400 to 700° C. for a period of 10 to 240 minutes. The magnesium oxide thus obtained was stored under airtight conditions.

### 1.2 Preparation of the Catalyst Pellets

7.5 g of sodium bentonite was blended with 135 g of demineralized water and suspended with a dispersion disk at 2000 rpm for 2 hours. 142.5 g of magnesium hydroxide was added to the suspension. Using an anchor stirrer, the mixture was processed to a homogeneous paste. By extrusion, the paste was processed to extrudates having diameters of 3 mm. These were then dried at 80 and 120° C. for 1 hour each. A sieve fraction in the range of 2-5 mm in the length of the particles was obtained by crushing and sieving the dried extrudates. The sieve fraction thus obtained was then calcined at a temperature range of 300 to 700° C. for a time period of 5 to 180 minutes under static air. The calcined extrudates thus obtained were stored in an airtight manner.

Beside the extrudates of Mg(OH)₂, pellets were formed from a mixture of Mg(OH)₂ and La(OH)₃. The weight ratio of the oxides La₂O₃:MgO was 1:9. The amount of inorganic binding agent sodium bentonite was 10% based on the starting material La(OH)₃ and Mg(OH)₂. The extrudates were prepared as described above. Calcination was carried out under static air for 180 minutes at 500° C. In the following, the catalyst pellets produced in this way are referred to as MgLaONaBe500.

### 1.3 Effect of Calcination

In order to examine the impact of calcination on the catalytic ability of metal oxides towards the polymerization and/or equilibration of siloxanes, untreated magnesium oxide was compared with calcined magnesium oxide. The used magnesium oxide had a purity of 99.995%. Calcination was carried out at 600° C. for 3 h under static air (MgO600). In the following, the untreated and the calcined magnesium oxide were dried at 80° C. and then at 120° C. for 1 h each. In each case, 0.5 g of the magnesium oxide samples were weighed into a reaction vessel, mixed with 0.5 g of demineralized water and 50 g of octamethylcyclotetrasiloxane, and stirred. The reaction temperature was 100° C. After 2 h, the conversion control was made by determining the dry substance The conversions obtained were 0.22% for the untreated MgO and 17.35% for MgO600 (FIG. 0).

### 2. Characterization of the Powdered Catalyst

Powdered magnesium oxide was prepared according to 1.1. The magnesium oxide was calcined at 400, 500, 600 and 700° C. In each case, the calcination time was 3 h. The catalysts thus prepared were referred to as MgO400, MgO500, MgO600 and MgO700 according to their calcination temperature.

### 2.1 Pore Size Distribution and Pore Volume

The pore size distribution (total pore volume TPV) and the pore volume were determined via N₂ physisorption with a Nova 4000e analyzer from Quantachrome Instruments. After weighing the catalyst into the measuring cell, the sample was degassed for 3 h at 120° C. under vacuum. Subsequently, the adsorption and desorption isotherms were measured at a constant temperature of 77 K with the aid of liquid nitrogen. The pore size distribution and the pore volume were calculated by using the Barett, Joyner and Halenda (BJH) method (DIN 66134).

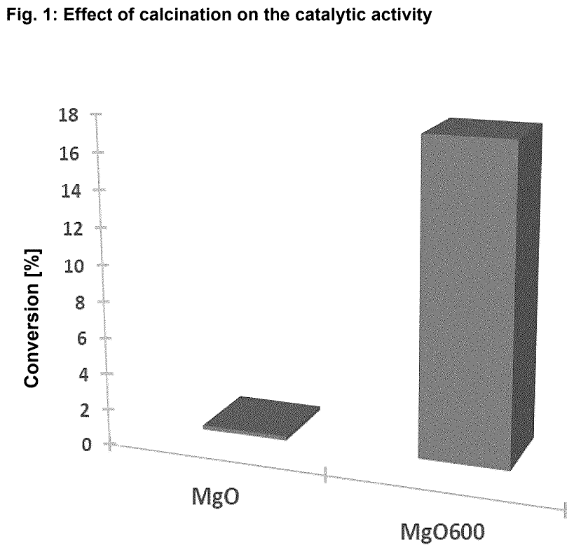

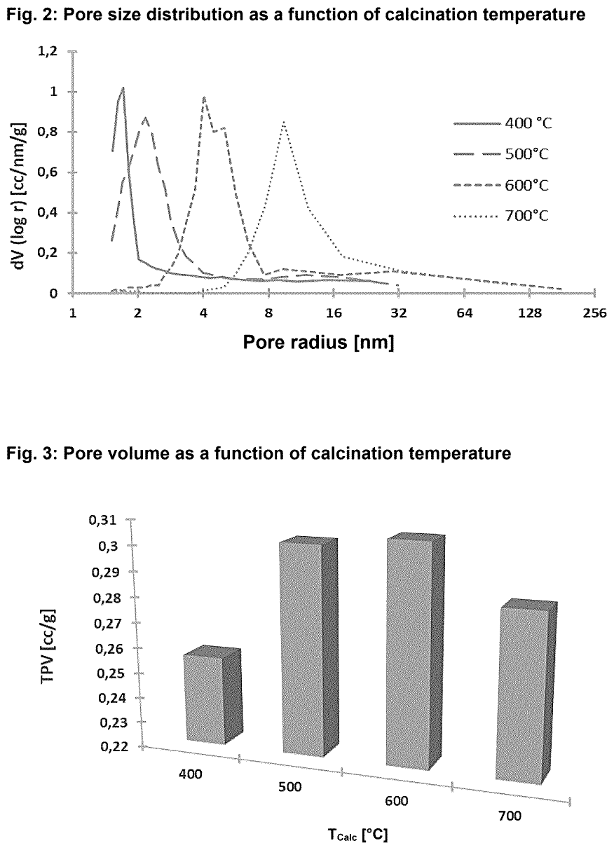

The impact of the calcination temperature on the pore size distribution (total pore volume TPV) and the pore volume is shown in FIGS. 1 and 2. It can be seen that the mean pore radius increases with increasing calcination temperature from 1.5 to 9.5 nm. In addition, the pore volume increases with increasing calcination temperature and reaches a maximum of 0.31 cc at 600° C.

### 2.2 Mass Specific Surface

The determination of the mass specific surface area (Sm) was carried out via N₂ physisorption using a Nova 4000e analyzer from Quantachrome Instruments. After weighing the catalyst into the measuring cell, the sample was degassed for 3 h at 120° C. under vacuum. Subsequently, the adsorption isotherm was measured at a constant temperature of 77 K with the aid of liquid nitrogen. The Brunauer-Emmett-Teller (BET) method (DIN ISO 9277) was used to measure and calculate the mass-specific surface area.

The results are shown in FIG. 3 for MgO400, MgO500, MgO600 and MgO700. It can be seen from the diagram that a decrease in mass specific surface area is observed with increasing calcination temperature. The mass-specific surface area of MgO400 is 220 m²/g and decreases continuously with increasing calcination temperature. Thus, MgO700 has a surface area of only 55 m²/g.

### 2.3 Production of Magnesium Oxide as a Function of Calcination Time

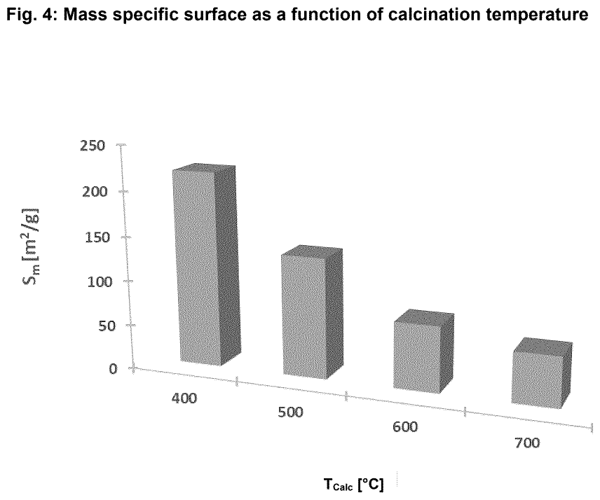

The effect of calcination time on magnesium hydroxide at a calcination temperature of 400° C. was examined via infrared measurement. The bands of pure and for 1, 2 and 3 h calcined magnesium hydroxide are shown in FIG. 4. the band at 3700 cm⁻¹ is well visible for the calcination time of 0 and 1 h, which is due to the —OH vibration in the Mg(OH)₂. This disappears completely after a calcination period of 2 and 3 h, respectively. Therefore, it can be assumed that the conversion of magnesium hydroxide to magnesium oxide is largely completed after 2 h.

### 2.4. Conversion

In order to test the activity of the prepared magnesium oxide powders as catalysts for the polymerization and/or equilibration of organosiloxanes, in a first step the powders prepared according to 1.1. were dried at 120° C. for 2 h. This provided for a uniform water content of 0.3%, which served as initiator. Next, 0.5 g of magnesium oxide was mixed with 75 g of octamethylcyclotetrasiloxane (OMCTS) and stirred at 100° C. After 2 h, the magnesium oxide was filtered off and the conversion was determined via the dry substance.

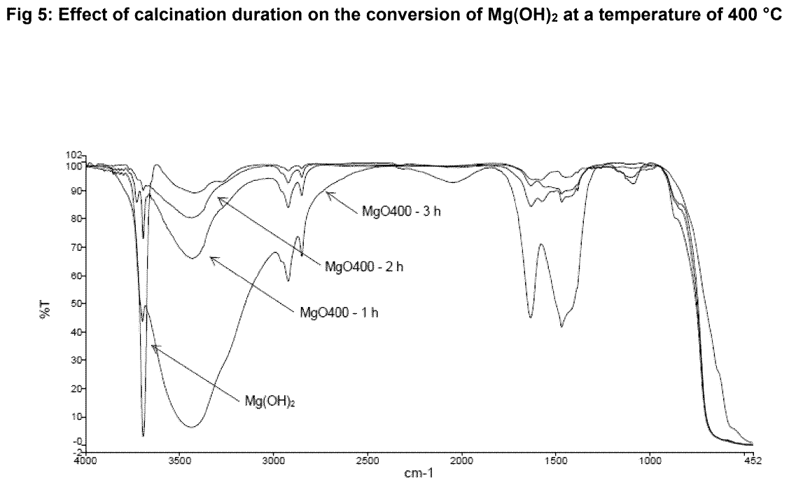

Surprisingly, the highest conversions were obtained with magnesium oxide calcined at 400 and at 500° C. (FIG. 5). For MgO600 and MgO700 the conversions decreased continuously.

### 3. Characterization of the Catalyst Pellets

The used catalyst pellets were prepared according to 1.2. The pellets were calcined at 400, 500 and 600° C. In each case, the calcination time was 3 h. The catalyst pellets thus prepared were referred to as MgNaBe400, MgNaBe500 and MgNaBe600 according to their calcination temperature.

### 3.1 Mass Specific Surface

The determination of the mass specific surface area (Sm) was carried out via N₂ physisorption using a Nova 4000e analyzer from Quantachrome Instruments. After weighing the catalyst pellets into the measuring cell, the samples were degassed for 3 h at 120° C. under vacuum. Subsequently, the adsorption isotherm was measured at a constant temperature of 77 K with the aid of liquid nitrogen. The Brunauer-Emmett-Teller (BET) method (DIN ISO 9277) was used to measure and calculate the mass-specific surface area.

Mass specific surface areas of 71.99 m²/g for MgNaBe400, 64.40 m²/g for MgNaBe500 and 44.82 m²/g for MgNaBe600 could be measured.

### 3.2 Pore Size Distribution and Pore Volume

The pore volume and pore size distribution were determined by mercury porosimetry according to DIN 66133. Before measurement, the extrudates were dried for 1 h at 120° C. and cooled to room temperature in a desiccator.

Pore volumes of 0.758 ml/g for MgNaBe400, 0.827 ml/g for MgNaBe500 and 0.746 ml/g for MgNaBe600 could be determined. The mean pore radius was 0.217 μm for MgNaBe400, 0.220 μm for MgNaBe500 and 0.201 μm for MgNaBe600.

### 3.3. Temperature-Programmed Desorption of CO₂ as a Measure of Base Strength

Via CO₂ adsorption, the base strength of the catalyst pellets prepared in 1.2. was examined. First, the samples were baked out under a helium atmosphere. The bake-out temperature was based on the calcination temperature. For the pellets calcined at 500 and 600° C., respectively, the bakeout temperature was 480° C., whereas for the pellets calcined at 400° C., the bakeout temperature was 400° C. In the following, CO₂ adsorption was carried out in a 100% CO₂ atmosphere at room temperature, followed by a purging process in order to remove lightly adsorbed CO₂ from the surface. Over a temperature ramp of 10° C./min, the desorption of CO₂ was now determined by a downstream gas chromatography.

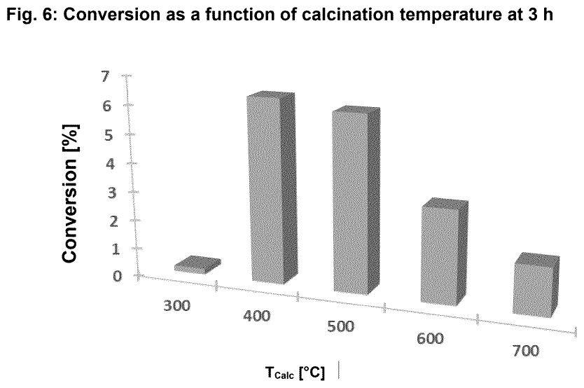

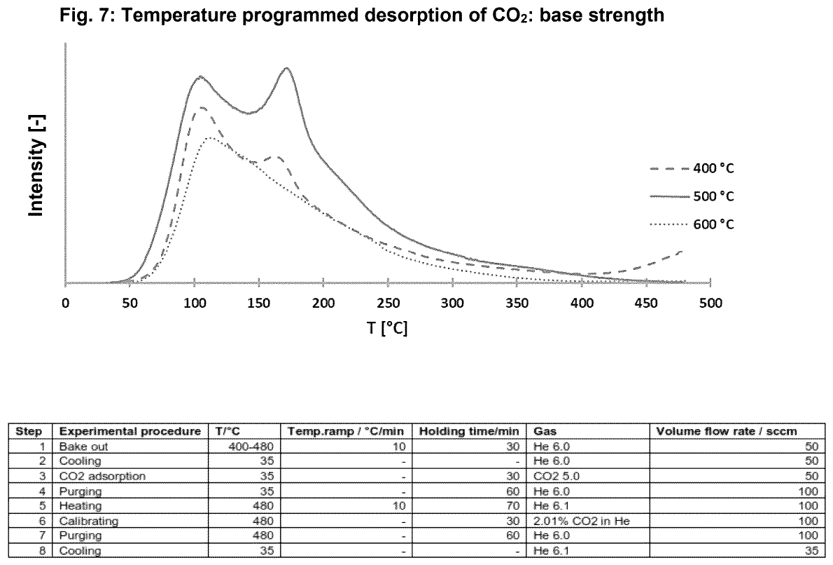

The results for the pellets prepared in 1.2. are shown in FIG. 6. All 3 catalyst pellets exhibit CO₂ desorption maxima at 100° C. Surprisingly, MgNaBe400 and MgNaBe500 exhibit another peak at 175° C. Uniquely, MgNaBe400 has an additional third peak, which is at T>450° C. Without being bound to any theory, MgNaBe400 and MgNaBe500 seem to have stronger basic centers compared to MgNaBe600.

By use of the Arrhenius and Kissinger equations (see Leon et al.), the CO₂ desorption enthalpies were determined. These were 59 kJ/mol for a bakeout temperature at 100° C., 90 kJ/mol at 175° C., and 200 kJ/mol at 450° C.

### 4. Fixed Bed Reactor

In order to test the catalyst characterized in item 2. under continuous reaction conditions, it was brought into pellet form as described under 1.2. in order to avoid an increased pressure loss in the fixed bed. The used sodium bentonite did not show catalytic activity towards the polymerization and/or equilibration of siloxanes, so that magnesium oxide can be assumed as the catalytic species.

The used reactor consisted of 4 modular stainless steel tubes connected in series having an inner diameter of 1.2 cm and a height of 50 cm, which corresponds to a total reaction volume of 56 cm³ per column. The catalyst volume corresponded to a total of 50 cm³ per column. The fixed bed could be heated via a heating jacket in a temperature range of 25 to 200° C. The reaction temperature was 80 to 160° C. and the WHSV was varied in a range from 10 to 30 h⁻¹. The educt solution of different compositions was fed into the reactor via a gear pump.

### EXAMPLE 1

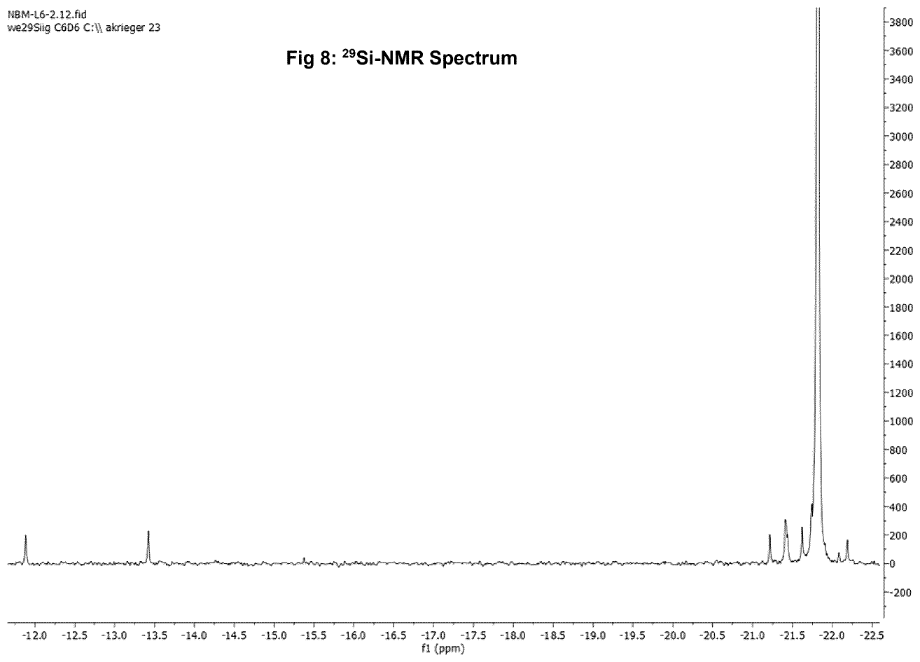

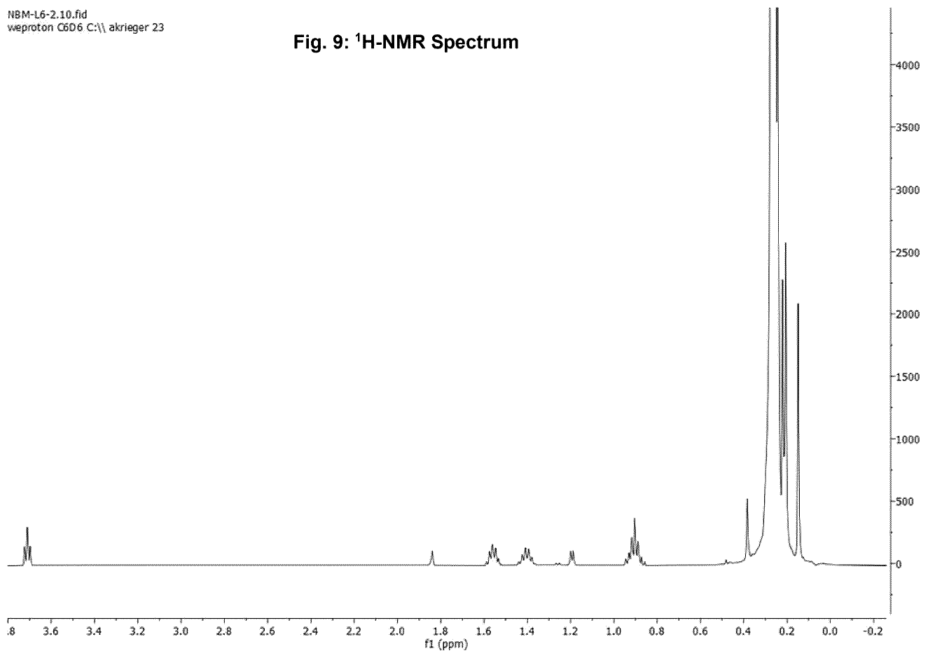

A reactant solution consisting of 483.6 g of octamethylcyclotetrasiloxane with 16.4 g of 1-butanol was continuously pumped into the fixed bed with a WHSV of 3 h⁻¹. As the fixed bed, 10 g of the catalyst MgONaBe600 prepared in 1.2 was used. The temperature of the fixed bed was maintained at 140° C. The product was concentrated on the rotary evaporator at 140° C. and 5 mbar. A clear colorless oil having a viscosity of 150 mPas at 25° C. was obtained and corresponded to a silicone of the following formula according to the results of the ²⁹Si and ¹H-NMR spectrum (FIGS. 7 and 8):

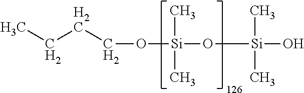

### EXAMPLE 2

A reactant solution consisting of 270 g of octamethylcyclotetrasiloxane, 30 g of 2,4,6,8-tetravinyl-2,4,6,8-tetramethylcyclotetrasiloxane and 6.12 g of trimethylsilanol was continuously pumped into the fixed bed with a WHSV of 6 h⁻¹. As the fixed bed, 10 g of the catalyst MgONaBe600 prepared in 1.2 was used. The temperature of the fixed bed was maintained at 140° C. A clear colorless oil having a viscosity of 130 mPas at 25° C. was obtained and corresponded to a silicone of the following formula according to the results of a ²⁹Si and ¹H-NMR spectrum:

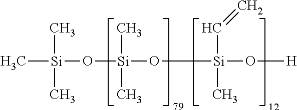

### EXAMPLE 3

A reactant solution consisting of 117 g of octamethylcyclotetrasiloxane, 12 g of a 3-aminopropyldiethoxysilane and 110 g of an α,ω-dihydroxypolydimethylsiloxane was continuously pumped into the fixed bed with a WHSV of 6 h⁻¹. As the fixed bed, 10 g of the catalyst MgONaBe600 prepared in 1.2 was used. The temperature of the fixed bed was maintained at 140° C. The product is a clear colorless oil having a viscosity of 130 mPas at 25° C. and corresponds to a silicone of the following formula according to the results of a ²⁹Si and ¹H-NMR spectrum:

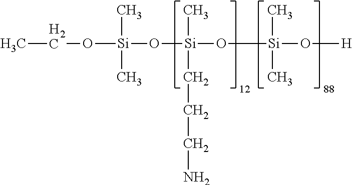

### EXAMPLE 4

A reactant solution consisting of 483.6 g of octamethylcyclotetrasiloxane, 16.4 g of 1-butanol and 10 g of dimethyl sulfoxide were continuously pumped into the fixed bed with a WHSV of 3 h⁻¹. As the fixed bed 10 g of the catalyst MgONaBe600 prepared in 1.2 was used. The temperature of the fixed bed was maintained at 140° C. It was found that by using dimethyl sulfoxide, the residence time could be reduced by 30% compared to Example 1. The product thus obtained was concentrated on the rotary evaporator at 140° C. and 5 mbar. A clear colorless oil having a viscosity of 150 mPas at 25° C. was obtained and corresponded to a silicone of the following formula according to the results of the ²⁹Si and ¹H-NMR spectrum:

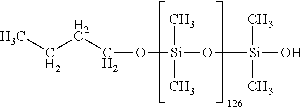

The proportion by weight of dimethyl sulfoxide in the product after distillation was less than 0.05%.

### EXAMPLE 5

An educt solution, as in Example 1, consisting of 483.6 g of octamethylcyclotetrasiloxane with 16.4 g of 1-butanol was provided. As the fixed bed, 10 g of the catalyst MgLaONaBe500 prepared in 1.2. was used. The temperature of the fixed bed was maintained at 140° C. The WHSV at which the input stream was pumped into the fixed bed could be increased from 3 to 6 h⁻¹ compared to Example 1 to still obtain the same conversions as in Example 1. The product was concentrated on the rotary evaporator at 140° C. and 5 mbar. A clear colorless oil having a viscosity of 150 mPas at 25° C. was obtained and corresponded to a silicone of the following formula according to the results of the ²⁹Si and ¹H-NMR spectrum:

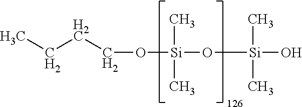

### EXAMPLE 6

In order to determine the contribution of condensation reactions to the polymerization reactions, a pure α,ω-dihydroxypolydimethylsiloxane was passed through the fixed bed. Due to the hydroxy groups at the terminal ends of the siloxane, water would be cleaved off during polycondensation.

By means of Karl Fischer titration the water content of the undistilled product was analyzed.

For this purpose, a reactant solution consisting of 500 g of an α,ω-dihydroxypolydimethylsiloxane was provided. The water content of the reactant solution, determined according to ISO 760, was 0.16%. As a fixed bed, 10 g of the catalyst MgONaBe600 prepared in 1.2. was used. The temperature of the fixed bed was maintained at 80° C. The WHSV at which the input stream was pumped into the fixed bed was 3 h⁻¹. An undistilled, clear colorless oil was obtained, which had a water content of 0.07%. It corresponded to a silicone of the following formula according to the results of the ²⁹Si and ¹H-NMR spectrum:

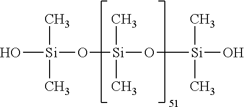

From the reduced amount of water in the final product, it can be concluded that part of the water acted as an initiator, but essentially no condensation reaction occurred.

The present invention is defined by the following items:
1. A catalyst pellet for anionic polymerization of organosiloxanes and/or for equilibration of organopolysiloxanes comprising
   (i) at least one (earth) alkali metal oxide and
   (ii) optionally at least one binding agent or at least one carrier material, characterized in that the CO₂ desorption enthalpy of the catalyst pellet is 25-350 kJ/mol, preferably 50-300 kJ/mol and particularly preferably from 50-200 kJ/mol, measured by temperature programmed desorption of CO₂.
2. The catalyst pellet according to item 1, wherein the (earth) alkali metal oxide (i) is sodium oxide, potassium oxide, rubidium oxide, cesium oxide, beryllium oxide, magnesium oxide, calcium oxide, strontium oxide or barium oxide, in particular calcium oxide or magnesium oxide, particularly preferred magnesium oxide.
3. The catalyst pellet according to any one of the preceding items, wherein the (earth) alkali metal oxide (i) has a mean pore radius of 2-130 nm, preferably 2-65 nm, more preferably 2-35 nm, measured according to DIN 66134.
4. The catalyst pellet according to any one of the preceding items, wherein the (earth) alkali metal oxide of component (i) has a specific pore volume of 0.2-1.2 ml/g, preferably 0.2-0.6 ml/g, more preferably, 0.2-0.45 ml/g, measured according to DIN 66134.
5. The catalyst pellet according to any one of the preceding items, wherein the (earth) alkali metal oxide of component (i) has a mass specific surface area of 35-400 m²/g, preferably 75-375 m²/g, more preferably 125-350 m²/g, measured according to DIN ISO 9277.
6. The catalyst pellet according to any one of the preceding items, wherein the proportion by weight of component (i) based on the total weight of the catalyst pellet is 0.1-100 wt %, preferably 1-100 wt %, more preferably 10-100 wt %, even more preferably 20-99.9 wt %, and most preferably 50-99.9 wt %.
7. The catalyst pellet according to item 2, wherein the (earth) alkali metal oxide magnesium oxide in an X-ray diffraction pattern (Cu-K_{α}: 0.154056 nm) has the five strongest signals at 2θ=37°, 43°, 62°, 75° and 78°, and the (earth) alkali metal oxide calcium oxide in an X-ray diffraction pattern (Cu-K_{α}: 0.154056 nm) has the six strongest signals at 2θ=32°, 37°, 53°, 64°, 67° and 79°.
8. The catalyst pellet according to any one of the preceding items, wherein the (earth) alkali metal oxide of component (i) is obtainable by calcination of the respective (earth) alkali hydroxide, (earth) alkali carbonate, (earth) alkali nitrate, (earth) alkali sulfate, (earth) alkali acetate, (earth) alkali oxalate, (earth) alkali phosphate, in particular the respective (earth) alkali hydroxide.
9. The catalyst pellet according to item 8, wherein calcination takes place at 300-900° C., preferably at 350-650° C., more preferably at 375-550° C., and preferably continues for 10-240 min, more preferably for 60-210 min, even more preferably for 90-150 min.
10. The catalyst pellet according to item 8 or 9, wherein calcination takes place under air, oxygen or inert gas atmosphere.
11. The catalyst pellet according to any one of the preceding items, wherein the binding agent of component (ii) is selected from organic or inorganic binding agents, preferably layered silicate, such as bentonite, sodium silicate, sodium aluminate, aluminosilicate, silica and esters thereof, as well as brines or colloidal solutions of silicon dioxide and, in a preferred embodiment, is catalytically inert.
12. The catalyst pellet according to any one of the preceding items, wherein the carrier material of component (ii) is selected from aluminium oxid, zirconium oxide, silicon dioxide, titanium oxide, titanium dioxide, metal phosphate such as hydroxyapatite, cerium oxide and carbon, and mixed oxides such as, for example, SiO₂—Al₂O₃, SiO₂—TiO₂, ZrO₂—SiO₂, ZrO₂—Al₂O₃ or mixtures of two or more of these materials.
13. The catalyst pellet according to any one of the preceding items, wherein the binding agent of component (ii) constitutes 0-40 wt %, preferably 0-20 wt %, more preferably 0.1-15 wt %, and more preferably 2-10 wt % based on the total weight of the catalyst pellet.
14. The catalyst pellet according to any one of the preceding items, wherein the carrier material of component (ii) constitutes 0-99.9 wt %, more preferably 0-80 wt %, and further preferably 0-50 wt % based on the total weight of the catalyst pellet.
15. The catalyst pellet according to any one of the preceding items, further comprising
   (iii) at least one oxide of an element of 3^{rd} to 12^{th} main groups or of the lanthanides, preferably in a proportion by weight of 1-50%, more preferably 5-30% and most preferably 5-25%, based on the (earth) alkali metal oxide of component (i).
16. The catalyst pellet according to any one of the preceding items, wherein the water content is 0.01-0.5 wt % based on the total weight of the catalyst pellet.
17. A method for preparing a catalyst pellet according to any one of items 1-16, comprising the steps:
   a) providing an (earth) alkali hydroxide, an (earth) alkali carbonate, an (earth) alkali nitrate, an (earth) alkali sulfate, an (earth) alkali acetate, an (earth) alkali oxalate, an (earth) alkali phosphate or a mixture thereof and optionally at least one hydroxide, carbonate, nitrate, acetate, oxalate, phosphate or sulfate of an element of the 3^{rd} to 12^{th} main groups or of the lanthanides as a starting material,
   b)
      b1) optionally, applying the starting material to a carrier material, or
      b2) optionally, mixing the starting material with at least one binding agent,
   c) providing the starting material or the mixture obtained after step b1) or b2) as a pellet precursor,
   d) optionally, drying of the pellet precursor obtained after step c) and
   e) calcining the pellet precursor obtained after step c) or d) in order to produce the catalyst pellet.
18. The method according to item 17, wherein the pellet precursor comprises
   1-100 wt % starting material,
   0-20 wt % binding agent or
   0-99 wt % carrier material,
   based on the total weight of the pellet precursor.
19. The method according to item 17 or 18, wherein the amount of solvent after step b) is 0-99 wt %, preferably 10-90 wt %, based on the total weight of the mixture.
20. The method according to any one of items 17-19, wherein step (c) is carried out by means of granulating, pressing, extruding, 3D printing, tabletting and spray drying the mixture obtained according to b).
21. The method according to any one of items 17-20, wherein the solvent content after step c) or d) is 0-10 wt % based on the total weight of the pellet precursor.
22. The method according to any one of items 17-21, wherein calcination in step e) is carried out at 300-900° C., preferably at 350-650° C., more preferably at 375-550° C., and preferably continues for 10-240 min, more preferably for 60-210 min, even more preferably for 90-150 min.
23. The method according to any one of items 17-22, wherein step e) is carried out under an air, oxygen, or inert gas atmosphere.
24. The catalyst pellet obtainable by a method according to any one of items 17-23.
25. The use of a catalyst pellet according to any one of items 1-16 or 24 for anionic polymerization of organosiloxanes and/or for equilibration of organopolysiloxanes.
26. A method for the anionic polymerization of organosiloxanes and/or for the equilibration of organopolysiloxanes by converting
   (A) organocyclosiloxanes of general formula (I)

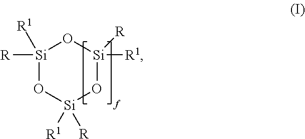

and/or linear block organopolysiloxanes of general formula (II)

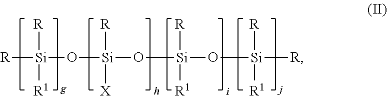

and linear, random or alternating organopolysiloxanes having the molecular formula of general formula (II),
   and optionally a compound of general formula (III)

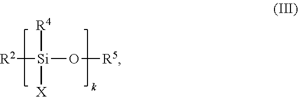

with
   (B) an initiator of general formula (IV)

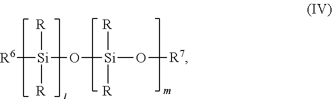

wherein
   R independently of each other is a monovalent, optionally substituted C₁-C₃₀ hydrocarbon residue,
   R¹ independently of each other is a monovalent, optionally substituted C₁-C₃₀ hydrocarbon residue or a polyether residue,
   f is an integer from 1 to 10, preferably an integer from 1 to 4, in particular 2,
   g is 0 or 1,
   h is 0 or an integer from 1 to 1000, preferably from 5 to 800,
   i is 0 or an integer from 1 to 1000, preferably from 5 to 800,
   j is 0 or 1,
   with the proviso that at least one of g, h, i, or j≠0.
   R² is a hydroxy group or —OR³,
   R³ is a monovalent C₁-C₃₀ hydrocarbon residue,
   R⁴ for k=1 is a monovalent C₁-C₃₀ hydrocarbon residue or R¹, and
      for k≠1 is independently of each other a monovalent C₁-C₃₀ hydrocarbon residue,
   R⁵ is a hydrogen or a monovalent C₁-C₃₀ hydrocarbon residue,
   X independently of each other is a monovalent C₁-C₃₀ hydrocarbon residue or a functionalized residue,
   k is an integer from 1 to 500, preferably from 1 to 400, more preferably from 1 to 300,
   R⁶ is R or hydrogen,
   R⁷ is R or hydrogen,
   l is 0 or 1,
      with the proviso that when l=0, R⁶ and/or R⁷ must be a hydrogen and when l≠0, R⁷ must be a hydrogen and R⁶ must be R, and
   m is 0 or an integer from 1 to 100, in particular from 5 to 80
   (C) in the presence of at least one catalyst pellet according to any one of items 1-16 or 24,
   (D) optionally in the presence of a solvent, and
   (E) optionally in the presence of a phase transfer catalyst.
27. The method according to item 26, wherein the method is carried out continuously.
28. The method according to any one of items 26-27, wherein the catalyst (C) is present in a different aggregate state than components (A), (B), and (D).
29. The method according to any one of items 26-28, wherein the catalyst (C) is present in an immobilized state.
30. The method according to any one of items 26-29, wherein the polyether residue is selected from a block polyether of general formula (V):

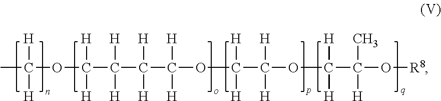

wherein
   R⁸ is a monovalent, optionally substituted C₁-C₃₀ hydrocarbon residue,
   n is 0 or an integer from 2-30,
   o is 0 or an integer between 1-50,
   p is 0 or an integer from 1-50, and
   q is 0 or an integer from 1-50,
   and a random or alternating polyether having the molecular formula of general formula (V).
31. The method according to any one of items 26-30, wherein a functionalized residue X is selected from general formula (VI):

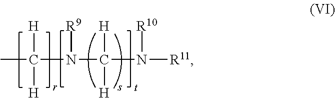

wherein
   R⁹ is R, a hydrogen or an acyl residue, preferably a hydrogen,
   R¹⁰ is R or a hydrogen, preferably hydrogen,
   R¹¹ is R, a hydrogen or an acyl residue, preferably hydrogen,
   r is an integer from 2-3
   s is an integer from 1-3
   t is 0 or an integer from 1 to 4, preferably 0 to 1.
32. The method according to any one of items 26-31, wherein the organocyclosiloxane of general formula (I) is octamethylcyclotetrasiloxane.
33. The method according to any one of items 26-32, wherein the organopolysiloxane of general formula (II) is preferably polydimethylsiloxane, e.g. hexamethyldisiloxane.
34. The method according to any one of items 26-33, wherein a compound of general formula (III) is (3-aminopropyl)dimethoxymethylsilane, (3-aminopropyl)trimethoxymethylsilane, [N-(2-aminoethyl)-3-aminopropyl)dimethoxymethylsilane, [N-(2-aminoethyl)-3-aminopropyl)trimethoxymethylsilane.
35. The method according to any one of items 26-34, wherein the initiator of general formula (IV) is butanol or trimethylsilanol.
36. The method according to any one of items 26-35, wherein the molar ratio of the initiator of general formula (IV) to compounds of formula (I) and/or (II) is between 0.003-1:1.
37. The method according to any one of items 26-36, wherein the solvent (D) is a non-polar organic solvent, preferably xylene, toluene, cyclohexane, heptane, octane, nonane or mixtures thereof.
38. The method according to any one of items 26-37, wherein the phase transfer catalyst (E) is benzyltriethylammonium chloride, crown ether, polyethylene glycol diethyl ether, or tertiary amines such as 4-dimethylaminopyridine or N,N-dimethylcyclohexylamine.
39. The method according to any one of items 26-38, wherein the conversion is carried out in a tubular reactor, fixed bed reactor, or loop reactor.
40. The method according to any one of items 26-39, wherein the conversion is carried out in a temperature range of 60-200° C., preferably 80-180° C.
41. The method according to any one of items 26-40, wherein the reaction is carried out at a weight hourly space velocity in the range of 1-30 h⁻¹, preferably 3-30 h⁻¹, more preferably 3-24 h⁻¹.
42. An organopolysiloxane obtainable by a method according to any one of items 26-41.

1. A catalyst pellet for the anionic polymerization of organosiloxanes and/or for the equilibration of organopolysiloxanes comprising
(i) at least one (earth) alkali metal oxide, in particular selected from sodium oxide, potassium oxide, rubidium oxide, cesium oxide, beryllium oxide, magnesium oxide, calcium oxide, strontium oxide or barium oxide, and
(ii) optionally at least one binding agent, in particular selected from phyllosilicate, such as bentonite, sodium silicate, sodium aluminate, aluminosilicate, silicic acid and its esters or
at least one carrier material, in particular selected from aluminum oxide, zirconium oxide, silicon dioxide, titanium oxide, titanium dioxide, metal phosphate, such as hydroxyapatite, cerium oxide, carbon, and mixed oxides such as SiO₂—Al₂O₃, SiO₂—TiO₂, ZrO₂—Al₂O₃ or mixtures of two or more of these materials,
wherein the CO₂ desorption enthalpy of the catalyst pellet is 25-350 kJ/mol, preferably 50-300 kJ/mol, measured by temperature programmed desorption of CO₂.

2. The catalyst pellet according to claim 1, wherein the (earth) alkali metal oxide (i) has an mean pore radius of 2-130 nm, preferably 2-65 nm, measured according to DIN-66134, and/or
has a specific pore volume of 0.2-1.2 ml/g, preferably 0.2-0.6 ml/g, more preferably 0.2-0.45 ml/g, measured according to DIN66134, and/or
a mass-specific surface area of 35-400 m²/g, preferably 75-375 m²/g, measured according to DIN ISO 9277.

3. The catalyst pellet according to claim 1, wherein the (earth) alkali metal oxide of component (i) is obtainable by calcining the respective (earth) alkali hydroxide, (earth) alkali carbonate, (earth) alkali nitrate, (earth) alkali sulfate, (earth) alkali acetate, (earth) alkali oxalate, (earth) alkali phosphate, in particular the respective (earth) alkali hydroxide, wherein the calcination preferably takes place at 300-900° C., more preferably at 350-650° C., and preferably continues for 10-240 min, more preferably for 60-210 min, even More preferably for 90-150 min, and wherein the calcination preferably takes place under an air, oxygen or inert gas atmosphere.

4. The catalyst pellet according to claim 1, further comprising,
(iii) at least one oxide of an element of the 3^{rd} to 12^{th} main groups or of the lanthanides, preferably in a proportion by weight of 1-50 wt %, more preferably 5-30 wt % and most preferably 5-25 wt % based on the (earth) alkali metal oxide of component (i).

5. A method of producing a catalyst pellet according to claim 1, comprising:
a) providing an (earth) alkali hydroxide, an (earth) alkali carbonate, an (earth) alkali nitrate, an (earth) alkali sulfate, an (earth) alkali acetate, an (earth) alkali oxalate, an (earth) alkali phosphate or a mixture thereof and optionally at least one hydroxide, carbonate, nitrate, sulfate, acetate, oxalate or phosphate of an element of the 3^{rd to} 12^{th} main groups or of the lanthanides as a starting material,
b)
b1) optionally applying the starting material to a carrier material, or
b2) optionally mixing the starting material with at least one binding agent,
c) providing the starting material or the mixture obtained after b1) or b2) as a pellet precursor, e.g. by extrusion or 3D printing,
d) optionally drying of the pellet precursor obtained after c) and
e) calcining the pellet precursor obtained after c) or d) to produce the catalyst pellet, wherein the calcining is carried out, for example, under air, oxygen or inert gas atmosphere, preferably at 300-900° C., more preferably at 350-650° C., and preferably lasts for 10-240 min, more preferably for 60-210 min.

6. A catalyst pellet obtainable by a method according to claim 5.

7. A method using the catalyst pellet according to claim 1 for anionic polymerization, in particular for polymerization of cyclic and linear organosiloxanes, and/or for equilibration of organopolysiloxanes.

8. A method for the anionic polymerization of organosiloxanes and/or for equilibration of organopolysiloxanes by converting
(A) organocyclosiloxanes of general formula (I) 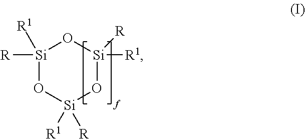
in particular octamethylcyclotetrasiloxane,
and/or linear block organopolysiloxanes of general formula (H), 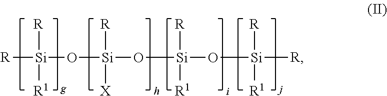
and linear, random or alternating organopolysiloxanes having the molecular formula of general formula (II) in particular hexamethyldisiloxane,
and optionally a compound of general formula (III) 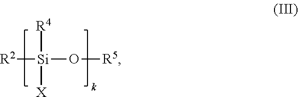
in particular (3-aminopropyl)dimethoxyrnethylsilane, 3-aminopropyl)trimethoxymethylsilane, [N-(2-aminoethyl)-3-aminopropyl)dimethoxymethylsilane, [N-(2-aminoethyl)-3-aminopropyl)trimethoxymethylsilane,
with
(B) an initiator of general formula (IV) 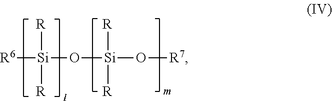
in particular butanol or trimethylsilanol,
wherein
R independently of each other is a monovalent, optionally substituted C₁-C₃₀ hydrocarbon residue,
R¹ independently of each other is a monovalent, optionally substituted C₁-C₃₀ hydrocarbon residue or a polyether residue,
f is an integer from 1 to 10, preferably an integer from 1 to 4, in particular 2,
g is 0 or 1,
h is 0 or an integer from 1 to 1000, preferably from 5 to 800,
I is 0 or an integer from 1 to 1000, preferably from 5 to 800,
j is 0 or 1,
with the proviso that at least one of g, h, i, or j≠0
R² is a hydroxy group or —OR³,
R³ is a monovalent C₁-C₃₀ hydrocarbon residue,
R⁴ for k≠1 is a monovalent C₁-C₃₀ hydrocarbon residue or R¹ and
for k≠1 is independently of each other a monovalent C₁-C₃₀ hydrocarbon residue,
R⁵ is a hydrogen or a monovalent C₁-C₃₀ hydrocarbon residue,
X independently of each other is a monovalent C₁-C₃₀ hydrocarbon residue or a functionalized residue,
K is an integer from 1 to 500, preferably from 1 to 400, more preferably from 1 to 300,
R⁶ is R or hydrogen,
R⁷ is R or hydrogen,
l is 0 or 1,
with the proviso that when l=0, R⁶ and/or R⁷ must be a hydrogen and when l≠0, R⁷ must be a hydrogen and R⁶ must be R, and
m is 0 or an integer front 1 to 100, in particular from 5 to 80
(C) in the presence of at least one catalyst pellet according to claim 1,
(D) optionally in the presence of a solvent, preferably xylene, toluene, cyclohexane, heptane, octane, nonane or mixtures thereof, and
(E) optionally in the presence of a phase transfer catalyst, in particular benzyltriethylammonium chloride, crown ether, polyethylene glycol diethyl ether or tertiary amines such as 4-dimethylaminopyridine or N,N-dimethylcyclohexylamine.

9. The method according to claim 8, wherein the method is performed continuously.

10. The method according to claim 8, wherein the catalyst (C) is present in an immobilized state.

11. The method according to claim 8, wherein the polyether moiety is selected from a block polyether of general formula (V): 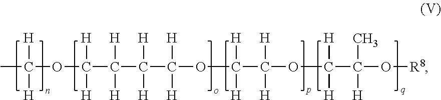
wherein
R⁸ is a monovalent, optionally substituted, C₁-C₃₀ hydrocarbon residue,
n is 0 or an integer from 2-30,
o is 0 or an integer between 1-50,
p is 0 or an integer from 1-50, and
q is 0 or an integer from 1-50,
and a random or alternating polyether having the molecular formula of general formula (V).

12. The method according to claim 8, wherein a functionalized residue X is selected from general formula (VI): 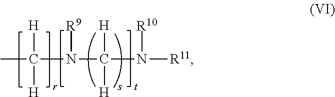
wherein
R⁹ is R, a hydrogen or an acyl residue; preferably a hydrogen,
R¹⁰ is R or a hydrogen, preferably hydrogen,
R¹¹ is R, a hydrogen or an acyl residue, preferably hydrogen.
r is an integer from 2-3
s is an integer from 1-3
t is 0 or an integer from 1 to 4, preferably 0 to 1.

13. The method according to claim 8, wherein the molar ratio of the initiator of general formula (IV) to compounds of formula (I) and/or (II) is between 0.003-1:1.

14. The method according to claim 8, wherein the conversion is carried out in a. tubular reactor, fixed bed reactor or loop reactor, preferably in a temperature range of 60-200° C., and preferably with a weight hourly space velocity in the range of 1-30 h⁻¹.

15. An organopolysiloxane obtainable by a method according to claim 8.
